(19) United States
(12) Patent Application Publication
(10) Pub. No.: US 2011/0123919 A1
(43) Pub. Date: May 26, 2011

(54) ELECTROPHOTOGRAPHIC TONER AND METHOD FOR PRODUCING ELECTROPHOTOGRAPHIC TONER

(75) Inventor: Takashi Urabe, Shizuoka-ken (JP)

(73) Assignee: TOSHIBA TEC KABUSHIKI KAISHA, Tokyo (JP)

(21) Appl. No.: 12/940,233

(22) Filed: Nov. 5, 2010

Related U.S. Application Data
(60) Provisional application No. 61/263,489, filed on Nov. 23, 2009.

(51) Int. Cl. G03G 9/09; G03G 9/08

(52) U.S. Cl. 430/108.21; 430/137.14

(57) ABSTRACT

A decolorable electrophotographic toner, which is produced by forming a coloring agent that imparts a color to the toner by heating a leuco dye and a color development and erasure controlling agent having a color developable structure that develops a color by reacting with the leuco dye and also having a decolorable structure that erases the color by inhibiting the contact of the leuco dye with the color developable structure in a dispersion liquid, thereby developing a color, pulverizing the coloring agent in the dispersion liquid by a high-pressure pulverization method, obtaining coloring agent particles maintained in a color developed state by cooling the pulverized coloring agent in the dispersion liquid to a temperature lower than the melting initiation temperature of the color development and erasure controlling agent at a cooling rate at which the color development and erasure controlling agent is not crystallized, and aggregating and fusing the coloring agent particles, binder resin particles, and release agent particles.

### CROSS-REFERENCE TO RELATED APPLICATION

This application is also based upon and claims the benefit of priority from U.S. provisional application 61/263,489, filed on Nov. 23, 2009; the entire contents of which are incorporated herein by reference.

### FIELD

Embodiments described herein relate to a technique for an electrophotographic toner capable of erasing an image formed on a recording medium by erasing the color.

### BACKGROUND

As a method for producing an electrophotographic toner, which contains a leuco dye, a color developing agent, and optionally a color erasing agent, and is capable of erasing an image formed on a recording medium by erasing the color, a melt-kneading method is usually adopted. The melt-kneading method is a method for producing desired toner particles by melt-kneading a binder resin, a leuco dye, a color developing agent, a release agent such as a wax, a charge control agent, and the like, cooling the resulting kneaded material, finely pulverizing the cooled material, and then, classifying the resulting fine particles.

However, if there is not a sufficient temperature difference between a temperature of the kneaded material when kneading and a color erasure initiation temperature, a bond between the leuco dye and the color developing agent is cleaved in a locally heated region, and colorless particles are sometimes generated. Further, in order to erase the color by the action of the decoloring agent, it is necessary that the leuco dye and the color developing agent be separated from each other and the color developing agent and the color erasing agent come into contact with each other. However, it takes time to allow the color developing agent and the color erasing agent to diffuse in the binder resin melted by heating, and as a result, it takes a lot of time until the color is erased.

### DESCRIPTION OF THE DRAWINGS

FIG. 1 is a process flow chart according to one example of a method for producing an electrophotographic toner of an embodiment.

FIG. 2 is a table showing the configurations of Examples and Comparative example according to an embodiment and image densities when images were formed using toners of Examples and Comparative example.

### DETAILED DESCRIPTION

In a method for producing a decolorable (color erasable) electrophotographic toner (hereinafter, also referred to merely as a toner) according to this embodiment, a coloring agent that imparts a color to the toner is formed by heating a leuco dye and a color development and erasure controlling agent having a color developable structure that develops a color by reacting with the leuco dye and also having a decolorable structure that erases the color by inhibiting the contact of the leuco dye with the color developable structure in a dispersion medium, thereby developing a color, the coloring agent in the dispersion medium is finely pulverized by a high-pressure pulverization method, coloring agent fine particles maintained in a color developed state are obtained by cooling the finely pulverized coloring agent in the dispersion medium to a temperature lower than the melting initiation temperature of the color development and erasure controlling agent at a cooling rate at which the color development and erasure controlling agent is not crystallized, and the coloring agent fine particles, and binder resin fine particles, and release agent fine particles are aggregated and fused.

Hereinafter, embodiments will be described with reference to the drawings.

In this embodiment, a toner containing a leuco dye, a color development and erasure controlling agent, a binder resin, and a release agent is produced. First, the constituent components of the toner will be described.

The leuco dye to be used can be appropriately determined by a person skilled in the art. Examples thereof include diphenylmethane phthalides, phenylindolyl phthalides, indolyl phthalides, diphenylmethane azaphthalides, phenylindolyl azaphthalides, fluorans, styrynoquinolines, and diaza-rhodamine lactones.

Specific examples thereof include 3,3-bis(p-dimethylaminophenyl)-6-dimethylaminophthalide, 3-(4-diethylaminophenyl)-3-(1-ethyl-2-methylindol-3-yl)phthalide, 3,3-bis(1-n-butyl-2-methylindol-3-yl)phthalide, 3,3-bis(2-ethoxy-4-diethylaminophenyl)-4-azaphthalide, 3-(2-ethoxy-4-diethylaminophenyl)-3-(1-ethyl-2-methylindol-3-yl)-4-azaphthalide, 3-[2-ethoxy-4-(N-ethylanilino)phenyl]-3-(1-ethyl-2-methylindol-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-N,N-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline, spiro[5H-(1)benzopyrano(2,3-d)pyrimidine-5,1′(3′H)isobenzo furan]-3′-one, 2-(diethylamino)-8-(diethylamino)-4-methyl-, spiro[5H-(1)benzopyrano(2,3-d)pyrimidine-5,1′(3′H)isobenzo furan]-3′-one, 2-(di-n-butylamino)-8-(di-n-butylamino)-4-methyl-, spiro[5H-(1)benzopyrano(2,3-d)pyrimidine-5,1′(3′H)isobenzo furan]-3′-one, 2-(di-n-butylamino)-8-(diethylamino)-4-methyl-, spiro[5H-(1)benzopyrano(2,3-d)pyrimidine-5,1′(3′H)isobenzo furan]-3′-one, 2-(di-n-butylamino)-8-(N-ethyl-N-1-amylamino)-4-methyl-, spiro[5H-(1)benzopyrano(2,3-d)pyrimidine-5,1′(3′H)isobenzo furan]-3′-one, 2-(di-n-butylamino)-8-(di-n-butylamino)-4-phenyl, 3-(2-methoxy-4-dimethylaminophenyl)-3-(1-butyl-2-methylindol-3-yl)-4,5,6,7-tetrachlorophthalide, 3-(2-ethoxy-4-diethylaminophenyl)-3-(1-ethyl-2-methylindol-3-yl)-4,5,6,7-tetrachlorophthalide, and 3-(2-ethoxy-4-diethylaminophenyl)-3-(1-pentyl-2-methylindol-3-yl)-4,5,6,7-tetrachlorophthalide. Additional examples thereof include pyridine compounds, quinazoline compounds, and bisquinazoline compounds. These compounds may be used by mixing two or more of them.

Further, the color development and erasure controlling agent according to this embodiment is a compound having a color developable structure that develops a color by reacting with the leuco dye and also having a color erasable structure that erases the color by inhibiting the contact of the leuco dye with the color developable structure. Examples of the color developable structure include a phenolic hydroxy group, a carboxylic acid group, and a phosphoric acid group. Further, examples of the color erasable structure include along-chain aliphatic hydrocarbon group. The aliphatic hydrocarbon group may be a linear chain or a branched chain. Specific examples of the long-chain aliphatic hydrocarbon group include a long-chain alkyl group and a long-chain alkenyl group.

The color development and erasure controlling agent may have another functional group in addition to the color developable structure and the color erasable structure. For example, the color development and erasure controlling agent may have a linking group in a linking region between the color developable structure and the color erasable structure. Examples of the linking group include a urea group (—NHCONH—) and an amide group (—NHCO—).

Also, the long-chain aliphatic hydrocarbon group may contain a similar linking group or an aromatic group. Further, the long-chain aliphatic hydrocarbon group may have a substituent bonded to the hydrocarbon group. Examples of the substituent include a hydroxy group, a halogen atom, and an alkoxy group.

Specific examples of the color development and erasure controlling agent include a compound having a structure as described below.

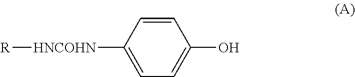

In the formula A, R represents a long-chain aliphatic hydrocarbon group.

In this embodiment, in the long-chain aliphatic hydrocarbon group, the number of carbons of the aliphatic hydrocarbon group contained is preferably from 12 to 28, more preferably from 16 to 24. If the number of carbons of the aliphatic hydrocarbon group contained is less than 12, the crystallinity is decreased and the color erasing property is decreased as compared with the case where the number of carbons is from 12 to 28. On the other hand, if the number of carbons of the aliphatic hydrocarbon group contained is more than 28, the melting point of the color developing agent is increased and the color erasing property is decreased as compared with the case where the number of carbons is from 12 to 28. Incidentally, when the long-chain aliphatic hydrocarbon group contains one or more linking groups or aromatic groups, the number of carbons of the aliphatic hydrocarbon group contained is the sum of the number of carbons of the hydrocarbon groups bonded via the linking groups or aromatic groups.

The binder resin constituting the toner according to this embodiment is not particularly limited and can be appropriately determined by a person skilled in the art.

As the binder resin, for example, a polyester resin obtained by subjecting a dicarboxylic acid component and a diol component to an esterification reaction followed by polycondensation, or a polystyrene resin can be used.

Among these components, examples of the dicarboxylic acid component include aromatic dicarboxylic acids such as terephthalic acid, phthalic acid, and isophthalic acid; and aliphatic carboxylic acids such as fumaric acid, maleic acid, succinic acid, adipic acid, sebacic acid, glutaric acid, pimelic acid, oxalic acid, malonic acid, citraconic acid, and itaconic acid.

Further, examples of the diol component include aliphatic diols such as ethylene glycol, propylene glycol, 1,4-butanediol, 1,3-butanediol, 1,5-pentanediol, 1,6-hexanediol, neopentyl glycol, trimethylene glycol, trimethylolpropane, and pentaerythritol; alicyclic diols such as 1,4-cyclohexanediol and 1,4-cyclohexanedimethanol; and an ethylene oxide or propylene oxide adduct of bisphenol A or the like.

Further, the above polyester component may be converted so as to have a crosslinking structure using a trivalent or higher polyvalent carboxylic acid component or a trihydric or higher polyhydric alcohol component such as 1,2,4-benzenetricarboxylic acid (trimellitic acid) or glycerin.

In the toner of this embodiment, two or more kinds of polyester resins having different compositions may be mixed and used.

Further, in the toner of this embodiment, the polyester resin may be crystalline or noncrystalline.

Further, as the polystyrene resin, a polystyrene resin obtained by copolymerization of an aromatic vinyl component and a (meth)acrylic acid ester component is preferred. Examples of the aromatic vinyl component include styrene, α-methylstyrene, o-methylstyrene, and p-chlorostyrene. Examples of the acrylic acid ester component include ethyl acrylate, propyl acrylate, butyl acrylate, 2-ethylhexyl acrylate, butyl methacrylate, ethyl methacrylate, and methyl methacrylate. Among these, butyl acrylate is generally used. As the polymerization method, a solution polymerization method is generally employed, and the resin is obtained by radical polymerization of monomers of the respective components in a solvent.

The glass transition temperatures of the polyester resin and the polystyrene resin are preferably 40° C. or higher and 65° C. or lower, and more preferably 45° C. or higher and 60° C. or lower. If the glass transition temperature is lower than 40° C., the storage stability is decreased as compared with the case where the glass transition temperature is in the above range, and the toner is solidified. On the other hand, if the glass transition temperature is higher than 65° C., the fixing temperature is increased as compared with the case where the glass transition temperature is in the above range.

The weight average molecular weight Mw of the polyester resin is preferably 4000 or more and 80000 or less. On the other hand, the weight average molecular weight Mw of the polystyrene resin is preferably 10000 or more and 70000 or less. If the weight average molecular weight Mw of the polyester resin is less than 4000 (in the case of the polystyrene resin, less than 10000), the heat-resistant storage stability of the toner is decreased as compared with the case where the weight average molecular weight Mw is in the above range. Further, if the weight average molecular weight Mw of the polyester resin is more than 80000 (in the case of the polystyrene resin, more than 70000), the fixing temperature is increased as compared with the case where the weight average molecular weight Mw is in the above range, and therefore, it is not preferred from the viewpoint of suppression of power consumption in a fixing treatment.

Further, the release agent to be contained in the toner according to this embodiment is not particularly limited, and examples thereof include aliphatic hydrocarbon waxes such as low molecular weight polyethylene, low molecular weight polypropylene, polyolefin copolymers, polyolefin waxes, microcrystalline waxes, paraffin waxes, and Fischer-Tropsch waxes; oxides of an aliphatic hydrocarbon wax such as polyethylene oxide waxes or block copolymers thereof; vegetable waxes such as candelilla wax, carnauba wax, Japan wax, jojoba wax, and rice wax; animal waxes such as bees wax, lanolin, and whale wax; mineral waxes such as ozokerite, ceresin, and petrolatum; waxes containing, as a main component, a fatty acid ester such as montanic acid ester wax and castor wax; and materials obtained by deoxidization of a part or the whole of a fatty acid ester such as deoxidized carnauba wax. Further, saturated linear fatty acids such as palmitic acid, stearic acid, montanic acid, and long-chain alkyl carboxylic acids having a long-chain alkyl group; unsaturated fatty acids such as brassidic acid, eleostearic acid, and parinaric acid; saturated alcohols such as stearyl alcohol, eicosyl alcohol, behenyl alcohol, carnaubyl alcohol, ceryl alcohol, melissyl alcohol, and long-chain alkyl alcohols having a long-chain alkyl group; polyhydric alcohols such as sorbitol; fatty acid amides such as linoleic acid amide, oleic acid amide, and lauric acid amide; saturated fatty acid bisamides such as methylene bisstearic acid amide, ethylene biscaprylic acid amide, ethylene bislauric acid amide, and hexamethylene bisstearic acid amide; unsaturated fatty acid amides such as ethylene bisoleic acid amide, hexamethylene bisoleic acid amide, N,N′-dioleyladipic acid amide, and N,N′-dioleylsebaccic acid amide; aromatic bisamides such as m-xylenebisstearic acid amide and N,N′-distearylisophthalic acid amide; fatty acid metal salts (generally called metallic soaps) such as calcium stearate, calcium laurate, zinc stearate, and magnesium stearate; waxes obtained by grafting of a vinyl monomer such as styrene or acrylic acid on an aliphatic hydrocarbon wax; partially esterified products of a fatty acid and a polyhydric alcohol such as behenic acid monoglyceride; and methyl ester compounds having a hydroxyl group obtained by hydrogenation of a vegetable fat or oil can be exemplified.

In addition, the toner of this embodiment may contain other components such as a charge control agent and an external additive.

As the charge control agent, a metal-containing azo compound is used, and the metal element is preferably a complex or a complex salt of iron, cobalt, or chromium or a mixture thereof. Further, a metal-containing salicylic acid derivative compound can also be used as the charge control agent. In the case of using a metal-containing salicylic acid derivative compound, the metal element is preferably a complex or a complex salt of zirconium, zinc, chromium, or boron, or a mixture thereof. By incorporating the charge control agent, a frictional charge quantity can be controlled.

Further, as the external additive, for example, in order to adjust the fluidity or chargeability, inorganic fine particles can be externally added and mixed in an amount of from 0.01 to 20% by mass based on the total mass of the toner particles. As such inorganic fine particles, silica, titania, alumina, strontium titanate, tin oxide, and the like can be used alone or by mixing two or more of them. It is preferred that as the inorganic fine particles, those surface-treated with a hydrophobizing agent are used from the viewpoint of improvement of environmental stability. Further, other than such inorganic fine particles, resin fine particles having a particle size of 1 μm or less may be externally added for improving the cleaning property.

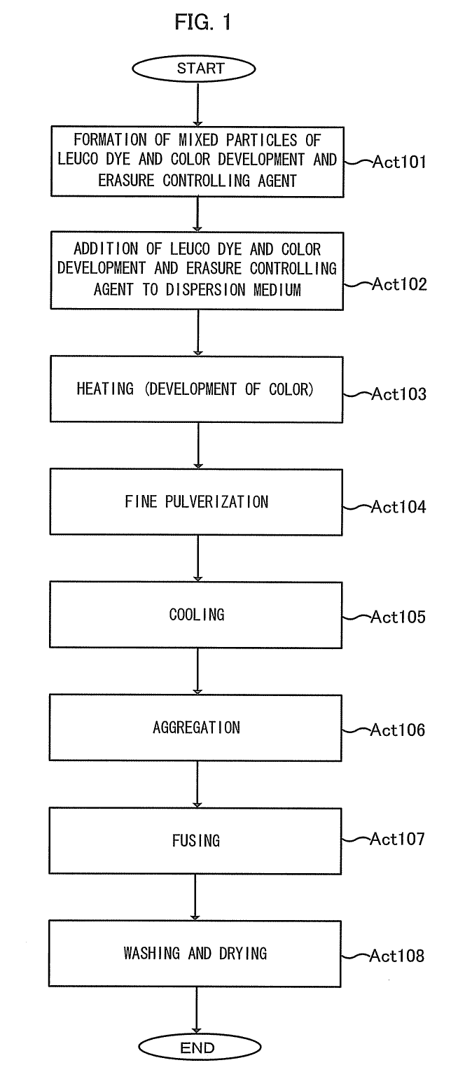

Subsequently, steps in the method for producing a toner of this embodiment will be described as an example with reference to the flow chart shown in FIG. 1.

In Act 101, first, a leuco dye and a color development and erasure controlling agent are kneaded, thereby forming crude particles. Then, the crude particles are crushed, thereby forming mixed particles of the leuco dye and the color development and erasure controlling agent. Incidentally, the mixing ratio of the leuco dye and the color development and erasure controlling agent is not particularly limited, however, the amount of the color development and erasure controlling agent is preferably from 1 to 6 parts by mass based on one part by mass of the leuco dye. Further, the heating temperature when the leuco dye and the color development and erasure controlling agent are kneaded can be appropriately determined by a person skilled in the art according to the specific types of the leuco dye and the color development and erasure controlling agent.

Subsequently, the formed mixed particles of the leuco dye and the color development and erasure controlling agent are heated to a temperature (Ta) in a dispersion medium to develop a color, thereby forming a coloring agent. Then, the coloring agent is finely pulverized in the dispersion medium by a high-pressure pulverization method, followed by cooling to a temperature lower than a temperature at which the leuco dye and the color development and erasure controlling agent are aggregated or crystallized, thereby obtaining coloring agent fine particles.

Incidentally, the coloring agent as used herein refers to one kind of compound or a composition that imparts a color to a toner. In this embodiment, the coloring agent contains a leuco dye and a color development and erasure controlling agent.

Further, the high-pressure pulverization method is a method of finely pulverizing particles by applying a pressure (for example, from 10 MPa to 300 MPa), and can be performed using, for example, a high-pressure pulverizer.

The high-pressure pulverizer is an apparatus configured to apply a shearing force by allowing a material to pass through a fine particle forming unit (a generator, for example, a fine nozzle) while applying a pressure of from 10 MPa to 300 MPa by means of a high-pressure pump to finely pulverize the material.

Further, the high-pressure pulverizer is generally provided with a cooling unit downstream of the generator that applies a shearing force. In this embodiment, the coloring agent finely pulverized by the high-pressure pulverization method is subsequently subjected to a cooling treatment, and in the case of using the high-pressure pulverizer, the cooling treatment can be performed by the cooling unit. As the cooling unit, a cooling coil that cools the fine particles in the dispersion liquid flowing therein by allowing a cooling medium to flow therearound can be used.

Specific examples of the high-pressure pulverizer include Nanomizer (manufactured by Yoshida Kikai Co. Ltd.), Ultimizer (manufactured by Sugino Machine Limited), NANO 3000 (manufactured by Beryu Co., Ltd.), Microfluidizer (manufactured by Mizuho Industry Co., Ltd.), and Homogenizer (manufactured by Izumi Food Machinery Co., Ltd.).

In this embodiment, a heating treatment, a fine pulverization treatment, and a cooling treatment can be successively performed using the high-pressure pulverizer having a heating system provided upstream of the generator. As the heating system, for example, an oil bath can be used, and the oil bath is configured to heat a pipe or a hopper for the dispersion liquid.

Hereinafter, a specific step of obtaining coloring agent fine particles will be described as an example.

First, in Act 102, the mixed particles of the leuco dye and the color development and erasure controlling agent are dispersed in a dispersion medium, thereby obtaining a dispersion liquid. The dispersion medium can be appropriately determined by a person skilled in the art, however, for example, ion exchanged water containing a surfactant can be used.

Subsequently, the thus obtained dispersion liquid is subjected to a high-pressure pulverizer provided with a heating system, and first, the dispersion liquid is heated to allow the leuco dye to develop a color, thereby forming a coloring agent (Act 103). The heating temperature is set to a temperature at which the leuco dye and the color development and erasure controlling agent are melt-mixed with each other to cause a contact reaction between the molecules of these components (more specifically, between the leuco dye and the color developable structure of the color development and erasure controlling agent), resulting in developing a color. A specific heating temperature (Ta) is appropriately set according to the structure or the like of each specific compound of the leuco dye and the color development and erasure controlling agent within a range from a temperature at which the development of a color is initiated to a temperature at which the thermal decomposition of the leuco dye is initiated.

Subsequently, the coloring agent particles contained in the heated dispersion liquid are finely pulverized by a generator of the high-pressure pulverizer (Act 104). Incidentally, the size of the formed fine particles can be appropriately determined according to the properties, particle size distribution or the like of a desired toner, however, it is preferably 1.2 μm or less. If it is more than 1.2 μm, there is a tendency that the volume average particle diameter of the toner obtained after aggregation and fusion is large or the particle size distribution is broad. Further, the lower limit of the size of the preferred fine particles is not particularly limited, however, for example, it is preferably 0.04 μm or more from the viewpoint of ease of controlling the particle diameter in the aggregation step or the like.

Further, the size of the fine particles can be set, for example, by adjusting the pressure on the basis of the measurement result of the size (for example, volume average particle diameter) of the fine particles obtained after the below-mentioned cooling treatment (feedback control).

Subsequently, in Act 105, the finely pulverized coloring agent is cooled to a temperature lower than the melting initiation temperature of the color development and erasure controlling agent at a cooling rate at which the color development and erasure controlling agent is not aggregated or crystallized in the cooling unit of the high-pressure pulverizer. By the cooling treatment, the color developed by the heating treatment can be stabilized.

The melting initiation temperature as used herein is a temperature at which an endothermic reaction leading to the melting peak temperature of the color development and erasure controlling agent according to this embodiment is initiated, and more specifically is an extrapolated melting initiation temperature as defined in JIS-K-7121. The extrapolated melting initiation temperature is a temperature represented by an intersecting point between a straight line that is obtained by extending the baseline on the lower temperature side to the higher temperature side and a tangent that is obtained at a point with the largest gradient on the curve of the melting peak on the lower temperature side.

Further, if cooling is not performed at a cooling rate at which the color development and erasure controlling agent is not aggregated or crystallized in the cooling treatment, the color development and erasure controlling agent is separated from the leuco dye and aggregated or crystallized, and as a result, the developed color is erased. When the color development and erasure controlling agent having a long-chain hydrocarbon group is used, a specific cooling rate is preferably set to 5° C./sec or more.

The upper limit of the cooling rate is not particularly limited, however, it is preferably set to 80° C./sec or less from the viewpoint of prevention of clogging of the cooling unit caused due to an abrupt phase change.

In the cooling treatment, a specific target cooling temperature (the temperature of the dispersion liquid after the cooling treatment) is preferably set to a temperature lower than the melting initiation temperature of the color development and erasure controlling agent by 20° C. or more from the viewpoint of suppression of a color erasing reaction.

That is, the cooling is preferably performed to a temperature at which the crystallization of the color development and erasure controlling agent is completely finished or lower.

The lower limit of the target cooling temperature is not particularly limited, however, it can be set to, for example, 5° C. or higher from the viewpoint of the stability of the dispersion liquid.

Subsequently, the coloring agent fine particles dispersed in the thus obtained dispersion liquid, binder resin fine particles, and release agent fine particles are aggregated by an emulsion aggregation method (Act 106). Thereafter, the aggregated particles are fused, thereby controlling the shape of a toner which is a final target product (Act 107).

In Act 106, first, a dispersion liquid of the coloring agent, a dispersion liquid of a finely pulverized binder resin, and a dispersion liquid of a finely pulverized release agent are mixed and stirred, thereby emulsifying and dispersing the respective components in a mixed dispersion liquid. Then, an aggregating agent is added to the mixed dispersion liquid, followed by heating, thereby allowing an aggregation reaction to proceed.

The type and addition amount of the aggregating agent can be appropriately determined by a person skilled in the art according to the types of the leuco dye, color development and erasure controlling agent, binder resin, and release agent, and the dispersion stability of the fine particles of the respective components. Further, the heating temperature in the aggregation treatment can also be appropriately determined by a person skilled in the art according to the types of the leuco dye, color development and erasure controlling agent, binder resin, and release agent.

Subsequently, in Act 107, the fluidity of the binder resin is increased by heating, thereby fusing the respective aggregated fine particles. The heating temperature in the fusing treatment can be appropriately determined within a range from the glass transition temperature of the binder resin to the color erasure initiation temperature of the coloring agent (a temperature at which the color development and erasure controlling agent dissociated from the leuco dye is independently aggregated or crystallized) according to the type of the binder resin to be used (more specifically, the glass transition temperature of the binder resin to be used).

Then, in Act 108, the thus obtained fused fine particles are washed and dried, thereby producing a toner. To the produced toner, an external additive is externally added as needed.

Incidentally, if a charge control agent or the like is incorporated, it may be added, for example, in the step of aggregation treatment.

A toner obtained by the method for producing a toner of this embodiment is mounted on an image forming apparatus such as a multifunction peripheral (MFP) in the same manner as a common toner, and is used for forming an image on a recording medium.

In an image forming step, for example, a toner image formed with the toner of this embodiment transferred onto a recording medium is heated at a fixing temperature in a fixing device mounted on an image forming apparatus, and as a result, the binder resin is melted and penetrates into the recording medium, and thereafter, the binder resin is solidified, thereby forming an image on the recording medium (fixing treatment).

Further, the image formed on the recording medium can be erased by performing a color erasing treatment of the toner. Specifically, the color erasing treatment can be performed by heating the recording medium on which the image is formed at a heating temperature (Td) not lower than the color erasure initiation temperature. For example, the color erasing treatment can be performed by setting the heating temperature of a fixing device mounted on an image forming apparatus to the color erasure initiation temperature and allowing a recording medium on which the image is formed to pass through the fixing device.

### EXAMPLES

Subsequently, the method for producing a toner of this embodiment will be described in more detail with reference to Examples. However, the invention is by no means limited to the following Examples.

### Example 1

### Synthesis of Color Development and Erasure Controlling Agent Having Long-Chain Hydrocarbon Group

1 mol of 1-octadecyl isocyanate and 1.2 mol of p-aminophenol were reacted in a methyl chloride under known conditions, followed by extraction with a mixed solution of methanol and methylene chloride, whereby a compound having a structure represented by the following formula (B) with a melting point of 143° C. was obtained as a color development and erasure controlling agent.

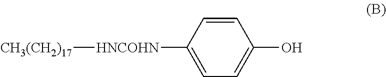

### Preparation of Coloring Agent Fine Particles

As a leuco dye, crystal violet lactone (CVL, manufactured by Hodogaya Chemical Co., Ltd.) was used. 1 kg of CVL and 1.5 kg of the synthesized color development and erasure controlling agent were mixed using a 20-L Henschel mixer and kneaded using a pressure kneader heated to 130° C. for 30 minutes, whereby a colorless kneaded material was obtained. Then, the obtained colorless kneaded material was coarsely crushed to a volume average particle diameter of 1 mm using a hammer mill (manufactured by Nara Machinery Co., Ltd.), whereby colorless coarse particles were obtained. Then, the coarse particles were further crushed using a pulverizer (manufactured by Hosokawa Micron, Co., Ltd.), whereby moderately crushed colorless particles having a volume average particle diameter of 68 μm were obtained.

10 parts by mass of the obtained moderately crushed colorless particles, 1 part by mass of sodium dodecyl benzene sulfonate as an anionic surfactant, and 89 parts by mass of ion exchanged water were stirred using a homogenizer (manufactured by IKA Japan K.K.), whereby a dispersion liquid 1 containing CVL and the color development and erasure controlling agent was obtained.

Then, the obtained dispersion liquid 1 was successively subjected to a heating treatment, a fine pulverization treatment, and a cooling treatment using Nanomizer (YSNM-200AR, manufactured by Yoshida Kikai Co., Ltd.) which is a high-pressure pulverizer provided with a heating system (oil bath), whereby a dispersion liquid containing coloring agent fine particles was obtained. The Nanomizer is provided with a heat exchange pipe with a length of 10 m immersed in an oil bath, a high-pressure pipe having a nozzle (generator) with a diameter of 100 μm, and a cooling coil (length: 20 m, volume: 158 cc) capable of allowing a cooling medium to flow therearound.

The temperature of the oil bath (hereinafter also referred to as the controlled temperature of the heating medium) in the heating treatment was set to 180° C.

Further, the treatment pressure in the generator was set to 120 MPa, and the fine pulverization treatment was performed only once. Further, the flow rate was 250 cc/min.

After the fine pulverization, the formed dispersion liquid containing coloring agent fine particles was cooled in the cooling coil (cooling medium: silicone oil, controlled temperature: 2° C.). The temperature of the dispersion liquid after the cooling treatment was 32° C., and in the Nanomizer, when the flow rate was 250 cc/min, the dispersion liquid passed through the cooling coil in 19 seconds, and therefore, the cooling rate was 7.8° C./sec.

The volume average particle diameter of the obtained coloring agent fine particles was measured using SALD-7000 (manufactured by Shimadzu Corporation) and found to be 0.364

### Preparation of Binder Resin Fine Particles

20 Parts by mass of a polyester resin (manufactured by Kao Corporation, glass transition temperature: 62° C., acid value: 20), 4 parts by mass of an anionic surfactant (Neopelex G-65, manufactured by Kao Corporation), 1 part by mass of an amine compound (triethylamine, manufactured by Wako Pure Chemical Industries, Ltd.), and 75 parts by mass of ion exchanged water were stirred at 18,000 rpm for 30 minutes using Clear Mix, followed by cooling, whereby a dispersion liquid of binder resin fine particles was obtained. The volume average particle diameter of the obtained binder resin fine particles in the dispersion liquid was measured using SALD-7000 and found to be 0.112 μm.

### Preparation of Release Agent Fine Particles

20 parts by mass of an ester wax (carnauba wax, manufactured by Toa Kasei Co., Ltd.), 1 part by mass of an anionic surfactant (Neopelex G-65, manufactured by Kao Corporation), and 79 parts by mass of ion exchanged water were mixed and processed using a homogenizer for 10 minutes while heating, whereby a dispersion liquid of wax fine particles having a volume average particle diameter of 0.152 μm (measured using SALD-7000) was obtained.

### Aggregation Treatment and Fusing Treatment

77.0 parts by mass of the dispersion liquid of binder resin fine particles, 3.8 parts by mass of the dispersion liquid of wax fine particles, and 19.2 parts by mass of the dispersion liquid of coloring agent fine particles were mixed and placed in a 1-L flask. Then, the mixture was stirred with a paddle impeller at 300 rpm and after it was confirmed that the temperature was stabilized at 30° C., 40 parts by mass of a 5% aqueous solution of magnesium sulfate was added thereto, and the temperature of the mixture was gradually raised to 70° C., whereby aggregated particles having a volume average particle diameter of 5.4 μm were obtained. The volume average particle diameter was measured using a coulter counter (aperture diameter: 100 μm).

Subsequently, 2 parts by mass of sodium dodecyl benzene sulfonate was added thereto as a dispersant for maintaining the volume average particle diameter of the coloring agent fine particles. Thereafter, a fusing treatment was performed by raising the temperature to 90° C. and leaving the mixture as such for 3 hours. Then, the fine particles were washed using a centrifugal separator until the electrical conductivity of the washing water became 50 μS/cm. Then, the fine particles were dried using a vacuum dryer until the water content became 0.3 wt %, whereby toner particles having a volume average particle diameter of 5.5 μm were obtained.

Incidentally, to the obtained toner particles, 4 parts by mass of silica (R972, manufactured by Japan Aerosil Co., Ltd.) was externally added using a Henschel mixer. Thereafter, coarse powder was removed using a vibration sieve.

### Example 2

A toner was produced in the same manner as in Example 1 except that the treatment pressure in the generator was set to 100 MPa and the flow rate in the generator and the cooling coil was set to 160 cc/min so as to change the cooling rate to 5° C./sec in the production process of the coloring agent fine particles.

### Example 3

A toner was produced in the same manner as in Example 1 except that the treatment pressure in the generator was set to 150 MPa and the flow rate in the generator and the cooling coil was set to 320 cc/min so as to change the cooling rate to 10° C./sec in the production process of the coloring agent fine particles.

### Example 4

A toner was produced in the same manner as in Example 1 except that the treatment pressure in the generator was set to 200 MPa and the flow rate in the generator and the cooling coil was set to 384 cc/min so as to change the cooling rate to 12° C./sec in the production process of the coloring agent fine particles.

### Example 5

A toner was produced in the same manner as in Example 1 except that the length of the cooling coil was set to 5 m, the controlled temperature of the cooling medium was set to 110° C. so as to change the cooling rate to 7.8° C./sec, and the dispersion liquid was cooled to 126° C. in the production process of the coloring agent fine particles.

### Example 6

A toner was produced in the same manner as in Example 5 except that the treatment pressure in the generator was set to 125 MPa, the flow rate in the generator and the cooling coil was set to 260 cc/min, the length of the cooling coil was set to 5 m, the controlled temperature of the cooling medium was set to 110° C. so as to change the cooling rate in the cooling treatment to 7.8° C./sec, and the dispersion liquid was cooled to 123° C. in the production process of the coloring agent fine particles.

### Example 7

A toner was produced in the same manner as in Example 1 except that the controlled temperature of the cooling medium was set to 70° C. so as to change the cooling rate in the cooling treatment to 8.2° C./sec, and the dispersion liquid was cooled to 90° C. in the production process of the coloring agent fine particles.

### Example 8

A toner was produced in the same manner as in Example 1 except that the controlled temperature of the heating medium was set to 150° C. and the controlled temperature of the cooling medium was set to 30° C. so as to change the cooling rate in the cooling treatment to 7.9° C./sec, and the dispersion liquid was cooled to 60° C. in the production process of the coloring agent fine particles.

### Example 9

A toner was produced in the same manner as in Example 1 except that the controlled temperature of the cooling medium was set to −10° C. so as to change the cooling rate in the cooling treatment to 8.6° C./sec, and the dispersion liquid was cooled to 20° C. in the production process of the coloring agent fine particles.

### Comparative Example 1

A toner was produced in the same manner as in Example 1 except that the treatment pressure in the generator was set to 80 MPa, the flow rate in the generator and the cooling coil was set to 96 cc/min, and the controlled temperature of the cooling medium was set to 2° C. so as to change the cooling rate in the cooling treatment to 3° C./sec in the production process of the coloring agent fine particles.

### Evaluation

Each of the toners of the respective Examples and Comparative example was mounted on MFP (e-STUDIO 281C) manufactured by Toshiba Tec Corporation, and a solid image was formed on paper.

The fixing temperature at this time was set to 110° C.

The density of each image formed on the paper by the image forming treatment using each of the toners of the respective Examples and Comparative example was measured using a Macbeth densitometer (manufactured by Gretag Macbeth Corporation, using a blue filter).

Subsequently, the paper on which a solid image was formed was set in a paper feed cassette of the above-mentioned MFP, and was allowed to pass through a fixing device by operating the MFP in a state that a new image was not output, whereby a color erasing treatment was performed. The temperature of the fixing device during the color erasing treatment was set to 150° C.

Each paper after the color erasing treatment was visually observed.

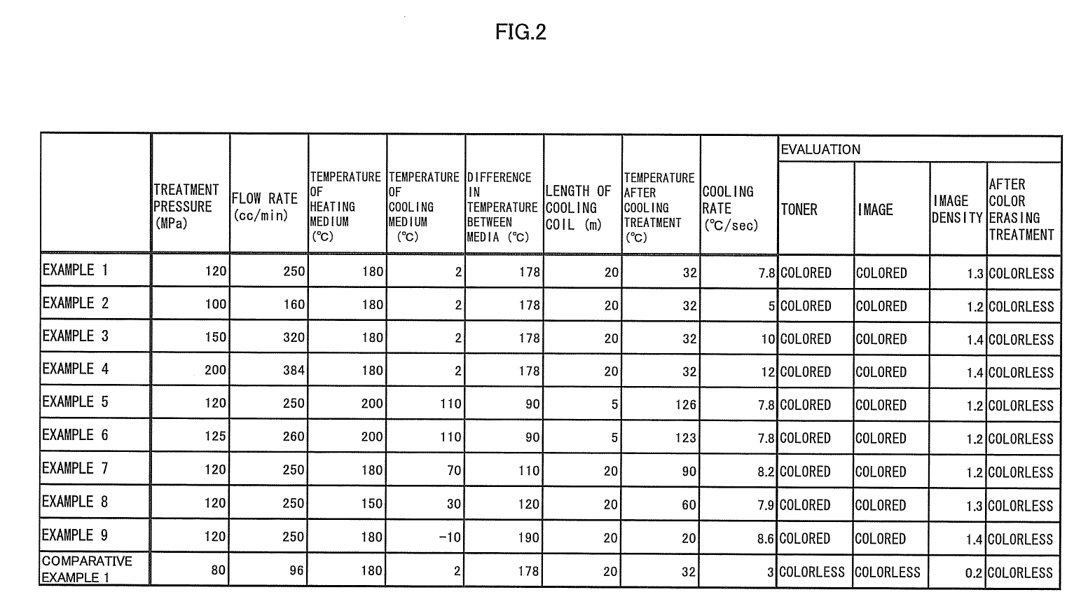

The results are shown in FIG. 2. As shown in FIG. 2, the toners of Examples could be produced while maintaining CVL in a color developed state.

Further, in the case of using the toners of Examples, an image could be formed on paper by the image forming treatment and also the image could be erased by the decoloring treatment.

On the other hand, in the case of using the toner of Comparative example, the color of CVL developed by the heating treatment could not be maintained after the cooling treatment, and also an image could not be formed by the image forming treatment.

While certain embodiments have been described, these embodiments have been presented by way of example only, and are not intended to limit the scope of invention. Indeed, the novel composition and methods described herein may be embodied in a variety of other forms; furthermore, various omissions, substitutions and changes in the form of the apparatus and methods and computer readable media described herein may be made without departing from the spirit of the inventions. The accompanying claims and their equivalents are intended to cover such forms or modifications as would fall within the scope and spirit of the inventions.

As described in detail above, according to the technique described herein, a method for forming a color erasable toner capable of instantaneously erasing an image can be provided.

What is claimed is:

1. A decolorable electrophotographic toner, which is produced by:
forming a coloring agent that imparts a color to the toner by dispersing in a liquid a leuco dye and a color development and erasure controlling agent having a color developable structure that develops a color by reacting with the leuco dye and also having a decolorable structure that erases the color by inhibiting the contact of the leuco dye with the color developable structure and heating the formed dispersion liquid;
pulverizing the coloring agent in the dispersion liquid by a high-pressure pulverization method;
cooling the pulverized coloring agent in the dispersion liquid to a temperature lower than the melting initiation temperature of the color development and erasure controlling agent at a cooling rate at which the color development and erasure controlling agent is not crystallized thereby obtaining the coloring agent particles maintained in a color developed state; and
aggregating and fusing the coloring agent particles, binder resin particles, and release agent particles.

2. The toner according to claim 1, wherein the color development and erasure controlling agent has a long-chain aliphatic hydrocarbon group as the color erasable structure.

3. The toner according to claim 2, wherein the color development and erasure controlling agent has an aliphatic hydrocarbon group having 12 to 28 carbon atoms as the long-chain aliphatic hydrocarbon group.

4. The toner according to claim 1, wherein the toner is produced by cooling the pulverized coloring agent at a cooling rate of 5° C./sec or more.

5. The toner according to claim 4, wherein the toner is produced by cooling the pulverized coloring agent at a cooling rate of from 5 to 80° C./sec.

6. The toner according to claim 1, wherein the toner is produced by cooling the pulverized coloring agent to a temperature lower than the melting initiation temperature of the color development and erasure controlling agent by 20° C. or more.

7. A method for producing a decolorable electrophotographic toner, comprising:
forming a coloring agent that imparts a color to the toner by dispersing in a liquid a leuco dye and a color development and erasure controlling agent having a color developable structure that develops a color by reacting with the leuco dye and also having a decolorable structure that erases the color by inhibiting the contact of the leuco dye with the color developable structure and heating the formed dispersion liquid;
pulverizing the coloring agent in the dispersion liquid by a high-pressure pulverization method;
cooling the pulverized coloring agent in the dispersion liquid to a temperature lower than the melting initiation temperature of the color development and erasure controlling agent at a cooling rate at which the color development and erasure controlling agent is not crystallized thereby obtaining the coloring agent particles maintained in a color developed state; and
aggregating and fusing the coloring agent particles, binder resin particles, and release agent particles.

8. The method according to claim 7, wherein the color development and erasure controlling agent has a long-chain aliphatic hydrocarbon group as the color erasable structure.

9. The method according to claim 8, wherein the color development and erasure controlling agent has an aliphatic hydrocarbon group having 12 to 28 carbon atoms as the long-chain aliphatic hydrocarbon group.

10. The method according to claim 7, wherein the pulverized coloring agent is cooled at a cooling rate of 5° C./sec or more.

11. The method according to claim 10, wherein the pulverized coloring agent is cooled at a cooling rate of from 5 to 80° C./sec.

12. The method according to claim 7, wherein the pulverized coloring agent is cooled to a temperature lower than the melting initiation temperature of the color development and erasure controlling agent by 20° C. or more.
